(19) United States
(12) Patent Application Publication
(10) Pub. No.: US 2025/0236306 A1
(43) Pub. Date: Jul. 24, 2025

(54) SYSTEM FOR MONITORING VEHICLE DYNAMIC LIMIT AND PROVIDING NOTICE TO DRIVER OF SAME

(71) Applicant: FCA US LLC, Auburn Hills, MI (US)

(72) Inventors: Travis D Bechtel, Goodrich, MI (US); Zachary A Luetzen, West Bloomfield, MI (US); Mark Stout, Auburn Hills, MI (US)

(21) Appl. No.: 18/417,375

(22) Filed: Jan. 19, 2024

(51) Int. Cl. B60W 50/12; B60W 10/18; B60W 10/20; B60W 20/10; B60W 30/02; B60W 30/14

(52) U.S. Cl. CPC B60W 50/12; B60W 10/18; B60W 10/20; B60W 20/10; B60W 30/02; B60W 30/143; B60W 2520/125; B60W 2520/28

(57) ABSTRACT

A system for control of a vehicle, includes a drive input operable by a person to control steering, acceleration or braking, a drive input actuator associated with the drive input and having an output to resist movement of the drive input, one or more sensors responsive to a dynamic parameter of the vehicle, and a control system communicated with the one or more sensors and the drive input. The control system is operable to cause the drive input actuator to increase resistance to movement of the drive input as a function of an output from the one or more sensors and a corresponding threshold to inhibit movement of the drive input in a way that would cause an increase in a magnitude of the dynamic parameter.

### FIELD

The present disclosure relates to a system for a vehicle that monitors a vehicle dynamic limit and provides notice to a driver of the vehicle before the dynamic limit is reached.

### BACKGROUND

Vehicles may include systems designed to control steering, brake or throttle inputs of the vehicle when the vehicle is at a dynamic limit which causes the vehicle to lose traction. Such systems damp or take over control of the output of the vehicle inputs and limit and interfere with a driver's control of the vehicle. In some instances, such as during performance driving, the interference caused is not desired by the driver yet the safety provided by such systems is still wanted. Accordingly, there is a need for, among other things, improved notice to the driver of vehicle dynamic limits and improved interaction with vehicle dynamic controls.

### SUMMARY

In at least some implementations, a system for control of a vehicle, includes a drive input operable by a person to control steering, acceleration or braking, a drive input actuator associated with the drive input and having an output to resist movement of the drive input, one or more sensors responsive to a dynamic parameter of the vehicle, and a control system communicated with the one or more sensors and the drive input. The control system is operable to cause the drive input actuator to increase resistance to movement of the drive input as a function of an output from the one or more sensors and a corresponding threshold to inhibit movement of the drive input in a way that would cause an increase in a magnitude of the dynamic parameter.

In at least some implementations, the vehicle has one or more vehicle dynamic control systems arranged to reduce a magnitude of a response from the drive input when a dynamic parameter that meets a first threshold is detected, and the control system operates the drive input actuator to increase resistance to movement of the drive input at a second threshold that is lower than the first threshold. In at least some implementations, the one or more vehicle dynamic control systems includes a traction control system operable to reduce a power output from a prime mover of the vehicle when the first threshold is exceeded, and the drive input is a throttle input actuated by a driver to increase vehicle speed. In at least some implementations, the one or more vehicle dynamic control systems is an anti-lock braking system operable to reduce a braking force of a braking system of the vehicle when the first threshold is exceeded, and the drive input is a brake input actuated by a driver to decrease vehicle speed or keep the vehicle from moving when the vehicle is stopped. In at least some implementations, the one or more vehicle dynamic control systems is a stability control system operable to control one or both of a braking force of a braking system of the vehicle or a power output of a prime mover of the vehicle, and the drive input is one of a brake input actuated by a driver to decrease vehicle speed or keep the vehicle stopped, or a throttle input actuated by a driver to increase vehicle speed.

In at least some implementations, the second threshold is between 2% and 20% lower than the first threshold.

In at least some implementations, the one or more sensors includes at least one accelerometer that is responsive to vehicle acceleration, and the first threshold is a magnitude of acceleration. In at least some implementations, the one or more sensors includes at least one wheel speed sensor, and the first threshold is set as a function of a wheel speed.

In at least some implementations, the drive input includes at least one of a throttle input operable to increase a vehicle speed and a brake input operable to decrease a vehicle speed.

In at least some implementations, a method of providing feedback to a vehicle driver, includes monitoring a vehicle dynamic parameter, operating a vehicle drive control when the vehicle dynamic parameter is beyond a first threshold to reduce a magnitude of actuation of the vehicle drive control, and operating an input actuator to increase resistance to driver caused movement of a drive input of the vehicle when the vehicle dynamic parameter is beyond a second threshold that is lower than the first threshold so that operating the input actuator occurs prior to operating the vehicle drive control.

In at least some implementations, the vehicle dynamic parameter is an acceleration of the vehicle and the drive control is one of a throttle control and a braking control, and the input actuator is associated with one of a throttle input and a brake input.

In at least some implementations, the input actuator is associated with one of a steering input and is arranged to require an increased force on the steering input to cause an increase in the steering angle of the vehicle.

In at least some implementations, the input actuator is associated with a throttle input and is arranged to require an increased force to for a given magnitude of movement of the throttle input.

In at least some implementations, the input actuator is associated with a brake input and is arranged to require an increased force to for a given magnitude of movement of the brake input.

In at least some implementations, the vehicle dynamic parameter is an acceleration of the vehicle and the first threshold is greater than the second threshold by 2% to 20%.

In at least some implementations, the vehicle dynamic parameter is a differential in vehicle wheel speed between at least two vehicle wheels, and the input actuator is associated with a throttle input and is arranged to require an increased force to for a given magnitude of movement of the throttle input.

In at least some implementations, the second threshold is determined as a function of an actuation of the vehicle drive control after the first threshold has been exceeded during a driving event.

In at least some implementations, a vehicle traction limit is determined as a function of the actuation of the vehicle drive control, and wherein the second threshold is determined as a function of the vehicle traction limit.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle showing various vehicle systems and components;

FIG. 2 is a diagrammatic view of a control system of the vehicle; and

FIG. 3 is a flowchart of a method of informing a driver that the vehicle is near a dynamic limit.

### DETAILED DESCRIPTION

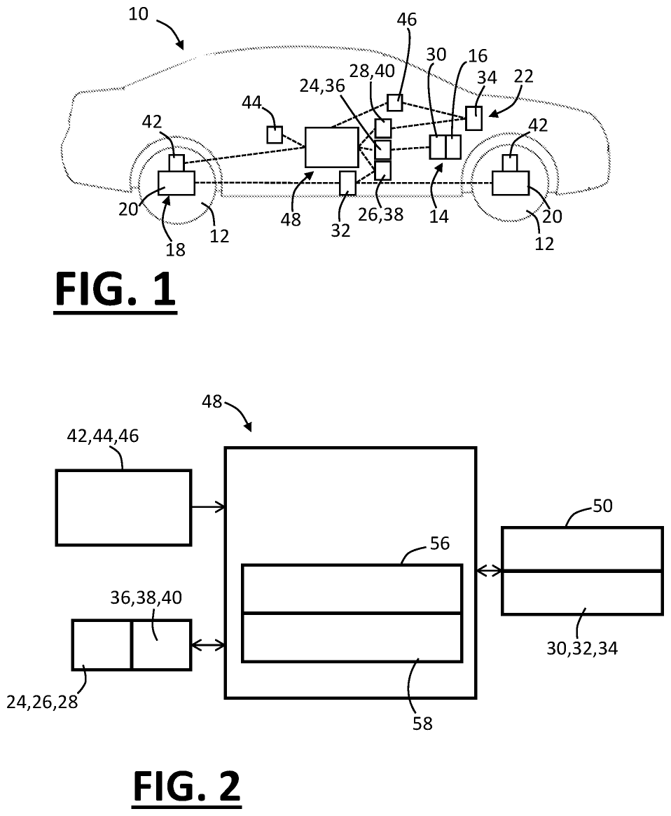

Referring in more detail to the drawings, FIG. 1 illustrates a vehicle 10 that includes multiple wheels 12, and a propulsion or drive system 14 that provides torque to the wheels 12 to rotate the wheels and accelerate the vehicle 10. The drive system 14 may be or include a prime mover 16, such as an electric motor, a combustion engine or both a motor and an engine (i.e. a hybrid drive system), and/or a transmission. The vehicle 10 may also include a brake system 18 that may include individual brake assemblies 20 associated with one or more of the wheels 12, to decelerate the vehicle 10 and hold still a stopped vehicle. To control the direction of vehicle travel, the vehicle 10 includes a steering system 22 by which the steering angle of the vehicle can be changed.

To control vehicle motion, the vehicle 10 includes drive inputs such as a throttle input 24, a brake input 26 and a steering input 28. The throttle input 24 is associated with the prime mover 16 so that actuation/movement of the throttle input 24 in a first direction causes an increase in power output from the prime mover 16 to increase vehicle speed. The throttle input 24 may be arranged in the vehicle for actuation by a driver, such as by a foot (e.g. a traditional foot-actuated throttle pedal) or a hand of the driver.

The brake input 26 is associated with the brake system 18 and arranged so that actuation of the brake input 26 actuates one or more brake assemblies 20 to reduce the vehicle speed or hold still a stopped vehicle. Like the throttle input 24, the brake input 26 may be arranged in the vehicle 10 for actuation by a driver, such as by a foot (e.g. a traditional foot-actuated brake pedal) or a hand of the driver.

The steering input 28 is associated with the steering system 22 and arranged so that movement of the steering input 28 causes a change in the steering angle and vehicle direction of travel. The steering input 28 may be arranged in the vehicle 10 for actuation by a driver, such as by a hand or hands or the driver (e.g. a traditional steering wheel or the like) or, less traditionally, one or both feet of the driver.

The throttle, brake and steering inputs 24, 26, 28 may be arranged in the vehicle 10 for actuation by a driver to permit driver control of the vehicle movement. The inputs 24, 26, 28 may be directly, mechanically linked to the corresponding vehicle systems (prime mover 16/drive system 14, brake system 18, steering system 22) or they may be communicated therewith in a so-called “by-wire” arrangement in which movement of the inputs 24, 26, 28 is communicated to drive control actuators associated with the vehicle systems, e.g. a throttle actuator 30, brake actuator 32 and a steering actuator 34. Such actuators may include electric motors or other electric actuators (e.g. electrically driven rotary or linear actuators) to cause a desired change in operation of the vehicle system.

Further, the throttle, brake and steering inputs 24, 26, 28 may each be associated with one or more input actuators, including a throttle input actuator 36, a brake input actuator 38 and a steering input actuator 40. The input actuators 36, 38, 40 may provide a desired force profile or “feel” for actuation of the inputs 24, 26, 28 to facilitate controlled movement of the inputs 24, 26, 28 and better driving control, and/or to provide a force feedback output noticeable by the driver. The input actuators 36, 38, 40 may include one or more actuators (e.g. electric, hydraulic, pneumatic actuators) that may assist or resist movement of the corresponding input.

Vehicle speed and acceleration may be determined by one or more wheel speed sensors 42 and/or accelerometers 44, and vehicle direction may be determined by one or more steering angle sensors 46. These sensors 42, 44, 46, among other things, may be communicatively coupled with a control system 48 to provide information to the control system 48 related to vehicle dynamics. As shown in FIG. 2, the control system 48 and sensors 42, 44, 46 may be used in control of one or move vehicle functions or systems, such as safety systems or other vehicle dynamic control systems 50 like anti-lock brake systems (ABS), vehicle electronic stability control systems (ESC), Traction Control (TC) system, and emergency braking or steering systems, and the like. These systems 50 may provide outputs from the control system 48 to the drive control actuators 30, 32, 34 to cause a desired output in one or more of the drive system 14, brake system 18 and steering system 22, in known manner.

In order to perform the functions and desired processing set forth herein, as well as the computations therefore, the control system 48 may include, but is not limited to, one or more controller(s) 56, processor(s), computer(s), DSP(s), memory 58, storage, register(s), timing, interrupt(s), communication interface(s), and input/output signal interfaces, and the like, as well as combinations comprising at least one of the foregoing. For example, the control system 48 may include input signal processing and filtering to enable accurate sampling and conversion or acquisitions of such signals from communications interfaces and sensors. As used herein the terms control system 48 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 48 may be distributed among different vehicle modules, such as an infotainment control module, engine control module or unit, powertrain control module, transmission control module, and the like, if desired.

The term “memory” 58 or “storage” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

As shown in FIG. 1, to permit measurement of the rotational speed of the wheels 12, the wheel speed sensor 42 may be associated with one of the wheels 12 to provide an output to the control system 48 that is indicative of the rotation of the wheel. The wheel speed sensor 42 may measure rotational speed, acceleration, or both. A separate wheel speed sensor 42 may be associated with each wheel 12. Further, acceleration may be determined by the derivative of rotary speed output(s) from the sensor. By way of a non-limiting example, the wheel speed sensor 42 may be a hall effect sensor with a magnet being rotated with the wheel or spindle and with a sensing element used to detect the magnet as it rotates by the sensing element. Of course, other types of rotational speed sensors may be used.

Additionally, acceleration may be measured using the accelerometer 44 which measures gravitational forces (i.e., g-forces) in forward and reverse directions, and or other directions including yaw and rotational directions. The vehicle 10 may include more than one accelerometer 44 arranged in or on the vehicle 10. In at least one embodiment, the accelerometer 44 may be a multi-axis accelerometer which provides simultaneous measurement of acceleration in three perpendicular axes, for example. The accelerometer 44 may measure normal acceleration which arises when torque is transferred from the propulsion system 16 to the wheels 12 and may also detect decelerating braking forces that arise when the brakes 20 of the vehicle 10 are applied or during engine braking, for example.

One or more systems of the vehicle 10 may rely on the wheel speed and vehicle acceleration data from the wheel speed sensors 42 and accelerometers 44 during operation of the vehicle 10. As noted above, the vehicle 10 may include different vehicle dynamic control system 50s to provide various levels of drive controls, for example, anti-lock brake system (ABS), traction control system (TCS), vehicle electronic stability control system (ESC), emergency braking or steering system, autonomous/semi-autonomous vehicle systems (AVS), and the like, may utilize some or all of the data from the wheel speed sensor 42 and/or the accelerometer 44.

In the vehicle dynamic control system 50 examples, ABS systems monitor wheel speeds and upon detection of wheel lock/sliding, the brake actuator 32 is managed, typically intermittently applied on and off, to inhibit wheels from sliding and provide a more controlled speed reduction. ESC systems monitor steering angle and one or both of wheel speed and accelerometer data, and in the case of the vehicle 10 sliding due to an acceleration outside of a threshold, the brake actuator 32 and/or throttle actuator 30 and/or steering actuator 34 may be controlled to reduce understeer or understeer, and/or to reduce power output from the prime mover 16 to control the vehicle travel along the intended path. Typical TCSs reduce throttle actuation when loss of motive traction or wheel slip is detected, to improve vehicle traction during acceleration events. Emergency braking and steering systems may control braking and steering actuators 32, 34 when the control system 48 determines a vehicle collision is likely, to reduce vehicle speed and/or maneuver the vehicle 10 away from an object. In these examples, the control system 48 operates various vehicle drive actuators 30, 32, 34 to control vehicle dynamics as a function of information from vehicle sensors.

While very helpful to improve safe driving in most instances, there may be situations in which a driver does not want the vehicle dynamic control system 50s to interfere with the driver's control of the vehicle 10. For example, when performance driving or racing, the driver may intentionally push the limits of the vehicle 10 and intend to drive near the point of traction or stability loss. In such instances, the reduction in speed caused by vehicle dynamic control systems 50 (e.g. ABS, ESC, TCS) due, for example, to brake application or throttle reduction, can interfere with the driving experience, increase lap times and be frustrating to the driver. Accordingly, when driving with vehicle dynamic control systems 50 active, a driver may attempt to control the vehicle 10 just below or within the thresholds for activation of these systems. In some vehicles, various vehicle systems can be turned off or have different levels of automated control to reduce the effects of intervention by such vehicle dynamic control systems 50, but some drivers prefer to leave the at least some of the systems active (e.g. ESC) to reduce the likelihood of total loss of control of the vehicle 10.

In at least some implementations, the vehicle control system 48 is arranged to operate one or more input actuators 36, 38, 40 associated with one or more of the vehicle drive controls, to provide an indication to the driver that the vehicle 10 is being operated near a threshold for activation of a vehicle dynamic control system 50. For example, if lateral acceleration, due to the combination of speed and steering angle and/or acceleration, is nearing a limit at which the ESC system may be activated, the control system 48 may operate one or more of the throttle input actuator 36 and the steering input actuator 40 and the brake input actuator 38 (e.g. in an example where too rapid a deceleration at a given steering angle can cause a loss of vehicle stability) to make one or more of increasing the steering angle or increasing the vehicle speed or increasing a braking force more difficult. The resistance to actuation of the throttle, brake or steering inputs 24, 26, 28 would be noticeable by a driver and provide notice to the driver that the vehicle stability limits are nearly reached. However, in at least some implementations, the input actuators 36, 38, 40 do not prevent further actuation of the inputs 24, 26, 28, and instead just provide feedback to the driver of the approaching vehicle limit(s). Further, in at least some implementations, the inputs 24, 26, 28 are not damped or reduced for a given magnitude of input actuation, and only the force required to move the inputs 24, 26, 28 is changed. In this way, the driver can still choose to further apply one or more of the inputs 24, 26, 28 and the input application for a given input movement may better align with driver expectations. The force applied to an input by an input actuator 36, 38, 40 may be variable, if desired, so that the closer the vehicle 10 gets to a given threshold, the greater the resistance to further actuation is applied to the associated input by the input actuator 36, 38, 40. Further, the resistance provided by the input actuator 36, 38, 40 could be constant/consistent or pulsed or otherwise intermittent, with variable force when pulsed, if desired.

Accordingly, in at least some implementations, when the vehicle 10 is approaching a threshold acceleration related to steering angle, the steering input actuator(s) 40 is/are operated to require a greater force be applied by the driver to turn the steering wheel 28 (for example) in a direction that increases the steering angle. Similarly, when the vehicle 10 is approaching a threshold acceleration related to vehicle speed or acceleration, the throttle input actuator(s) 36 is/are operated to require a greater force be applied by the driver to move the throttle input 24 (e.g. press the accelerator pedal) to cause an increase in vehicle speed. And when the vehicle 10 is approaching a threshold acceleration related to brake force/deceleration, the brake input actuator(s) 38 is/are operated to require a greater force be applied by the driver to actuate the brake input 26 to cause an increase in braking force.

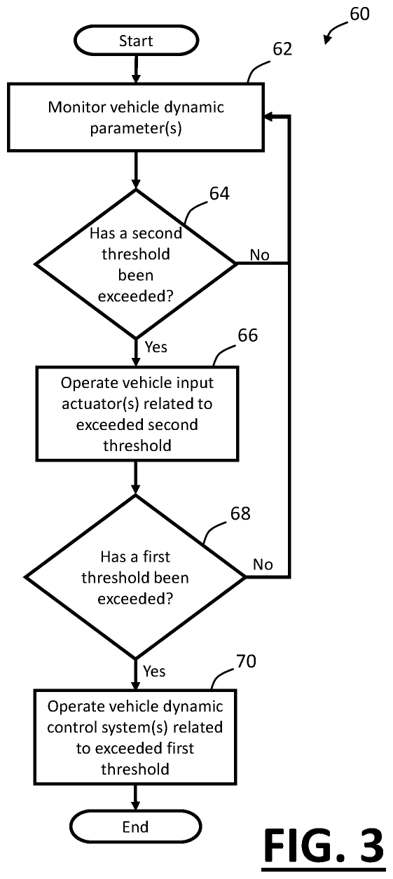

As shown in FIG. 3, a method 60 for providing feedback to a vehicle driver may be implemented to control, for example, the input actuator 36, 38, 40 for one or more, and up to all of the throttle, brake and steering inputs 24, 26, 28. In at least some implementations, the method may include step 62 in which a vehicle dynamic parameter is monitored. The vehicle dynamic parameter may be one or more parameters that affect the control of the vehicle 10, and may be the parameter or parameters that are monitored by other systems, such as the vehicle dynamic control systems 50 like ABS, TC, ESC and the like, and may include, for example, vehicle speed, wheel speed(s), acceleration(s).

Such parameters are monitored with respect to one or more thresholds, and the method may include, in step 64, determining if a second threshold relating to the monitored dynamic parameter has been exceeded. If so, the method moves to step 66 and if not, the method may return to start for continued monitoring of the dynamic parameter(s). In step 66, a vehicle input actuator associated with the exceeded second threshold is operated to alert a driver that the vehicle is nearing a dynamic limit.

The method may then continue to step 68 in which it is determined if a first threshold relating to the monitored dynamic parameter has been exceeded. If so, the method moves to step 70 and if not, the method may return to start for continued monitoring of the dynamic parameter(s). In step 70, one or more vehicle drive control(s) is/are operated when the vehicle dynamic parameter being monitored is beyond a first threshold, to reduce a magnitude of actuation of the vehicle drive control. Examples of this step include actuation of the ABS, TC or ESC systems that may operate the brake, throttle or steering systems to try and bring the vehicle dynamic parameter back under or within the first threshold.

As noted above, the method system disclosed herein may be implemented to provide information or feedback to a driver of the vehicle 10 prior to the dynamic parameter exceeding the first threshold, and prior to the automatic actuation of the vehicle drive control noted above. To do this, a second threshold is set that is less than the first threshold, where “less than” means that the second threshold will be met and exceeded before the first threshold. In at least some implementations, the second threshold may be set as a function of the first threshold, such as between 2% and 20% less than the first threshold.

As noted above, in step 66, operation of an input actuator increases resistance to driver caused movement of a drive input 24, 26, 28 of the vehicle 10 when the vehicle dynamic parameter is beyond the second threshold. In this way, operating the input actuator occurs prior to operating the vehicle drive control and provides information to the driver prior to the vehicle systems interfering with one or more vehicle drive controls (throttle, braking, steering). As noted above, the input actuator may be operated to resist driver movement of one or more of the throttle, brake and steering inputs when the second threshold is met or exceeded. This resistance can be felt by the driver who must exert greater effort to move the input(s) and by this the driver will understand that the vehicle 10 is approaching the first threshold at which the vehicle systems will interfere with one or more vehicle drive controls. Further, the input actuator output may be variable over the range between the second threshold and the first threshold. For example, the output resistive force may increase as the vehicle dynamic parameter gets close to the first threshold, to provide an increasing resistance to driver movement of an input, or the output may be pulsed (e.g. at a third threshold between the second threshold and the first threshold) at varying rate and magnitude or otherwise controlled to provide a range of feedback to the driver, as desired.

The thresholds may be set as a function of many variables that affect vehicle dynamics and traction. Examples of parameters that can affect vehicle traction, include tire type and performance characteristics, tire temperature and pressure, road surface temperature, road surface type, decreased road friction conditions (e.g. rain/snow/ice), vehicle speed related downforce (e.g. aerodynamic effects, which may include effects from static or dynamic aerodynamic components like spoilers, wings, splitters, etc.), vehicle weight/load, vehicle torque capability, vehicle rate of acceleration, suspension setting/performance characteristics, and the like. Still other factors can affect vehicle performance like braking capacity, brake temperature and regenerative braking status.

In view of these and other variables, the tractive limits of the vehicle 10 can vary greatly in different conditions and it can be difficult for a driver to know the traction limits of the vehicle 10 in a given situation. It is desirable to provide feedback to the driver when the vehicle 10 is near the first threshold, or near activation of a vehicle dynamic control system 50 that will interfere with driver control of the vehicle, but allowing the driver input actuators to operate too soon or too often could be annoying to the driver or reduce driver performance. To accommodate a wide range of conditions, the thresholds can be varied (increased or decreased) to match the vehicle's response and performance in those conditions. Further, in at least some implementations, the first threshold may be set as a function of, or only after, a vehicle dynamic control system 50 is activated during a driving session. This can provide a baseline for setting thresholds (first and second) for various dynamic parameters as a function of the information learned during the driving session, to provide more accurate and time and conditions relevant thresholds. For example, a vehicle traction limit can be determined based on actual conditions of the road, ambient, tires being used, and the like, and that traction limit can be used to determine various acceleration or wheel speed thresholds. This may enable the thresholds to be more accurately determined based on actual conditions relating to traction.

In performance driving situations, a driver or other person may enter values into the control system 48 for relevant variables, like road surface type, wetness of the road surface, ambient temperature, tire type, tire temperature, road surface temperature, throttle or brake mapped profiles, driving mode (track, sport, etc) and the like. From this information, the system can determine thresholds for various vehicle dynamic parameters and operate the input actuators as a function of these parameters. In addition to or instead of such manual entry of information, the vehicle 10 may determine this information from on board sensors (for things like tire pressure, tire temperature, position of any active aerodynamic components, moisture/rain, throttle/torque response, etc) and systems, or from data sources (e.g. providing weather, road and/or driving/racetrack conditions) uploaded to or downloaded by the control system 48 (e.g. via a telematics unit).

Further, the second threshold may be manually entered as a function of “g-force” (gravitational force equivalent) experienced by the vehicle. Performance vehicles sometimes include displays of g-forces, e.g. from accelerometer data, and drivers may be accustomed to limits as a function of the g-force on the vehicle. In this regard, the vehicle may handle g-forces in different directions or orientations differently (fore-aft accelerations during straight vehicle travel vs. lateral accelerations as the vehicle is turning) and the driver may be able to set thresholds for different directions or orientations of g-forces. By way of a non-limiting example, if the vehicle can manage 1.1 g due to lateral acceleration while turning, the driver or other person could set the second threshold to be something less than 1.1 g, for example, 1.0 g or otherwise as desired. Still further, the second threshold(s) could be a range of thresholds set at different speeds. This may permit the second threshold to be closer to the first threshold when the vehicle is traveling at lower speeds, and enable a greater buffer or difference between the thresholds at higher speeds, where the consequences of losing control of the vehicle can be more severe.

Providing varying force/displacement in the driver actuated input controls becomes a proactive means of informing the driver that the vehicle 10 is near/reaching a particular performance limit. This is an enhancement to the “seat of the pants” feel that the driver would otherwise rely on, which requires the vehicle 10 to being to lose traction and the resulting force change/sensation to be detected by the driver. That said, the system may set one or more thresholds as a function of an occurrence of an activation of a vehicle dynamic control system 50 during a driving session, as noted above. This concept can still employ the current reactive technologies, like ABS, TC and ESC, as a safety measure.

Additionally, the systems and methods can be used to communicate adverse conditions, faults or defects detected by the vehicle 10 directly through the control interfaces, complimentary to what otherwise may be a gauge reading, a warning light or an audible alert. In this way, limitation or force resistance to a drive control input can alert the driver that the vehicle 10 is not operating properly in some respect.

The systems and methods can have significant affect in applications on vehicles that employ powered, active or passive aerodynamic downforce generation. These aerodynamic features can dramatically change the tractive capabilities of the vehicle 10 at different speeds, different aerodynamic settings or powered downforce generation conditions, and such large differences in traction can be difficult for a driver to determine or judge. The feedback system and methods can be tuned to communicate the downforce status directly to enable a driver to more accurately determine the current tractive limits over a wide range of conditions.

Finally, the systems and methods can be used as a training tool for drivers in applications where the vehicle 10 may employ autonomous driving systems and track mapping. In this application, the controls can be driven to move without user input, allowing the driver to feel/learn the magnitudes and rates of application in a more meaningful manner than just seeing/following the steering control follow the racing line of the track. The system can further be used to train a driver actively controlling the vehicle 10, such as during warm-up laps or test runs on the track.

What is claimed is:

1. A system for control of a vehicle, comprising:
a drive input operable by a person to control steering, acceleration or braking;
a drive input actuator associated with the drive input and having an output to resist movement of the drive input;
one or more sensors responsive to a dynamic parameter of the vehicle; and
a control system communicated with the one or more sensors and the drive input, wherein the control system is operable to cause the drive input actuator to increase resistance to movement of the drive input as a function of an output from the one or more sensors and a corresponding threshold to inhibit movement of the drive input in a way that would cause an increase in a magnitude of the dynamic parameter.

2. The system of claim 1 which also includes one or more vehicle dynamic control systems arranged to reduce a magnitude of a response from the drive input when a dynamic parameter that meets a first threshold is detected, and wherein the control system operates the drive input actuator to increase resistance to movement of the drive input at a second threshold that is lower than the first threshold.

3. The system of claim 2 wherein the one or more vehicle dynamic control systems includes a traction control system operable to reduce a power output from a prime mover of the vehicle when the first threshold is exceeded, and wherein the drive input is a throttle input actuated by a driver to increase vehicle speed.

4. The system of claim 2 wherein the one or more vehicle dynamic control systems is an anti-lock braking system operable to reduce a braking force of a braking system of the vehicle when the first threshold is exceeded, and wherein the drive input is a brake input actuated by a driver to decrease vehicle speed or keep the vehicle from moving when the vehicle is stopped.

5. The system of claim 2 wherein the one or more vehicle dynamic control systems is a stability control system operable to control one or both of a braking force of a braking system of the vehicle or a power output of a prime mover of the vehicle, and wherein the drive input is one of a brake input actuated by a driver to decrease vehicle speed or keep the vehicle stopped, or a throttle input actuated by a driver to increase vehicle speed.

6. The system of claim 1 wherein the second threshold is between 2% and 20% lower than the first threshold.

7. The system of claim 2 wherein the one or more sensors includes at least one accelerometer that is responsive to vehicle acceleration, and the first threshold is a magnitude of acceleration.

8. The system of claim 2 wherein the one or more sensors includes at least one wheel speed sensor, and the first threshold is set as a function of a wheel speed.

9. The system of claim 2 wherein the drive input includes at least one of a throttle input operable to increase a vehicle speed and a brake input operable to decrease a vehicle speed.

10. A method of providing feedback to a vehicle driver, comprising:
monitoring a vehicle dynamic parameter;
operating a vehicle drive control when the vehicle dynamic parameter is beyond a first threshold to reduce a magnitude of actuation of the vehicle drive control; and
operating an input actuator to increase resistance to driver caused movement of a drive input of the vehicle when the vehicle dynamic parameter is beyond a second threshold that is lower than the first threshold so that operating the input actuator occurs prior to operating the vehicle drive control.

11. The method of claim 10 wherein the vehicle dynamic parameter is an acceleration of the vehicle and the drive control is one of a throttle control and a braking control, and the input actuator is associated with one of a throttle input and a brake input.

12. The method of claim 10 wherein the input actuator is associated with one of a steering input and is arranged to require an increased force on the steering input to cause an increase in the steering angle of the vehicle.

13. The method of claim 10 wherein the input actuator is associated with a throttle input and is arranged to require an increased force to for a given magnitude of movement of the throttle input.

14. The method of claim 10 wherein the input actuator is associated with a brake input and is arranged to require an increased force to for a given magnitude of movement of the brake input.

15. The method of claim 10 wherein the vehicle dynamic parameter is an acceleration of the vehicle and the first threshold is greater than the second threshold by 2% to 20%.

16. The method of claim 10 wherein the vehicle dynamic parameter is a differential in vehicle wheel speed between at least two vehicle wheels, and the input actuator is associated with a throttle input and is arranged to require an increased force to for a given magnitude of movement of the throttle input.

17. The method of claim 10 wherein the second threshold is determined as a function of an actuation of the vehicle drive control after the first threshold has been exceeded during a driving event.

18. The method of claim 17 wherein a vehicle traction limit is determined as a function of the actuation of the vehicle drive control, and wherein the second threshold is determined as a function of the vehicle traction limit.
